(19) United States
(12) Patent Application Publication
(10) Pub. No.: US 2025/0063508 A1
(43) Pub. Date: Feb. 20, 2025

(54) METHOD FOR SIGNAL PROCESSING

(71) Applicant: ZTE CORPORATION, Shenzhen (CN)

(72) Inventors: Xuan MA, Shenzhen (CN); Mengzhu CHEN, Shenzhen (CN); Jun XU, Shenzhen (CN); Bo DAI, Shenzhen (CN); Qiujin GUO, Shenzhen (CN); Xiaoying MA, Shenzhen (CN); Youjun HU, Shenzhen (CN)

(73) Assignee: ZTE CORPORATION, Shenzhen (CN)

(21) Appl. No.: 18/933,605

(22) Filed: Oct. 31, 2024

Related U.S. Application Data
(63) Continuation of application No. PCT/CN2022/123381, filed on Sep. 30, 2022.

(51) Int. Cl. H04W 52/02; H04W 56/00; H04W 68/02; H04W 74/0833

(52) U.S. Cl. CPC H04W 52/0235; H04W 56/0015; H04W 68/02; H04W 74/0833

(57) ABSTRACT

A wireless communication method is disclosed. The method comprises transmitting, by a wireless communication terminal to a wireless communication node, a wake-up request comprising wake-up information in one or more wake-up occasions to indicate the wireless communication node to perform one or more operations.

### CROSS-REFERENCE TO RELATED APPLICATION

This application claims the benefit of priority under 35 U.S.C. § 120 as a continuation of International Patent Application No. PCT/CN2022/123381, filed on Sep. 30, 2022, the disclosure of which is incorporated herein by reference in its entirety.

### TECHNICAL FIELD

This document is directed generally to wireless communications, and in particular to 5^{th} generation (5G) communications.

### BACKGROUND

The bandwidth of the 5G cell is more than five times of that of the 4G cell. In addition, the 64/32-channel Massive MIMO equipment with high complexity is used outdoors, leading to extremely high power consumption of the 5G base station.

### SUMMARY

Currently, the gNodeB (gNB) can reduce power consumption by using some energy saving technologies, such as channel shutdown, carrier shutdown, etc.

However, these network-energy-saving technologies may have problems without UE feedback. If the energy saving states are too short, the energy saving gain is limited. If the energy saving states lasts for a long time, user experience may be greatly affected.

Therefore, it is a technology that needs to be considered to transition between energy saving settings and non-energy saving settings.

For NR, there are some necessary common signals/channel transmissions or receptions, for example the SSB (Synchronization Signal Block), SIB1 (System Information Block), paging, and PRACH (Physical Random Access Channel).

Therefore, the network cannot easily enter the low power consumption state, e.g., the sleep mode. In addition, even if the network devices can enter sleep states, if a semi-static configuration is used, the devices can be awakened only after sleeping for a period of time. If there is a service requirement in sleeping states, it cannot meet the requirement, which will cause great delay and affect user experience.

Embodiments of the present disclosure proposes several methods and systems, as exemplified in the following paragraphs.

One aspect of the present disclosure relates to a wireless communication method. In an embodiment, the wireless communication method includes: transmitting, by a wireless communication terminal to a wireless communication node, a wake-up request comprising wake-up information in one or more wake-up occasions to indicate the wireless communication node to perform one or more operations.

Another aspect of the present disclosure relates to a wireless communication method. In an embodiment, the wireless communication method includes: receiving, by a wireless communication node from a wireless communication terminal, a wake-up request comprising wake-up information in one or more wake-up occasions; and performing, by the wireless communication node, one or more operations according to the wake-up request.

Another aspect of the present disclosure relates to a wireless communication terminal. In an embodiment, the wireless communication terminal includes a transceiver and a processor. The processor is configured to: transmit, via the transceiver to a wireless communication node, a wake-up request comprising wake-up information in one or more wake-up occasions to indicate the wireless communication node to perform one or more operations.

Another aspect of the present disclosure relates to a wireless communication node. In an embodiment, the wireless communication node includes a transceiver and a processor. The processor is configured to: receive, by the transceiver from a wireless communication terminal, a wake-up request comprising wake-up information in one or more wake-up occasions; and perform one or more operations according to the wake-up request.

Various embodiments may preferably implement the following features:

Preferably or in some embodiments, the wake-up information comprises at least one of: an indication indicating one or more of the common signal or channel transmissions, an indication indicating one or more of the common signal or channel receptions, or a feedback transmitted to the wireless communication node,

Preferably or in some embodiments, the common signal or channel comprises at least one of a Synchronization Signal/Physical Broadcast Channel Block, SSB, a System Information Block, SIB, a paging, a Sounding Reference Signal, SRS, or a Physical Random Access Channel, PRACH.

Preferably or in some embodiments, the one or more operations comprises at least one of: transmitting SSBs, transmitting SIBs, receiving a PRACH, receiving SRS, transmitting paging, transmitting on-demand reference signal, RS, or transmitting a feedback to the wireless communication node.

Preferably or in some embodiments, transmitting the SSBs comprises at least one of: transmitting SSBs a predetermined number of times periodically from a next SSB burst occasion, transmitting SSBs a predetermined number of times repeatedly within one or more SSB cycles, transmitting SSBs within a duration periodically, or transmitting SSBs with a new SSB period from a next SSB burst occasion.

Preferably or in some embodiments, transmitting the SIBs comprises at least one of: transmitting SIBs a predetermined number of times periodically from a next SIB occasion, transmitting SIBs within a duration periodically, or transmitting SIBs with a new SIB period from a next SIB burst occasion.

Preferably or in some embodiments, at least one of the predetermined number, the duration, the new SSB period, or the new SIB period is associated with at least one of a fixed value, configured by high layer parameter, times of SSB cycle, or times of SIB cycle.

Preferably or in some embodiments, the wake-up request is not detected by the wireless communication node within a validation time of the wake-up request, or
the one or more operations are restarted when a new wake-up request is detected within a validation time of the wake-up request, or
the wake-up information in the new wake-up request is ignored when the new wake-up request is detected within a validation time of the wake-up request.

Preferably or in some embodiments, the wake-up occasions are associated with at least one of: a cycle of the one of the wake-up occasions, indication information transmitted from the wireless communication node to the wireless communication terminal, a random access channel, RACH, occasion, a paging occasion, a paging frame, PF, or a paging early indication, PEI.

Preferably or in some embodiments, the cycle of the wake-up occasions is associated with at least one of: a high layer parameter, a paging cycle, an SSB transmission period, a discovery burst duty cycle, or a predetermined value.

Preferably or in some embodiments, the wake-up request is transmitted according to at least one of: a measurement result, a random access requirement, a data transmission requirement, a state of the wireless communication node, the one or more wake-up occasions are enabled, or an event that the wireless communication terminal fails to detect a common signal within a duration.

Preferably or in some embodiments, the wireless communication terminal performs at least one of the following operations before transmitting the wake-up request: receiving SSBs with a pre-defined cycle, receiving SSBs N times before the one or more wake-up occasions, receiving a Tracking Reference Signal, TRS, before the one or more wake-up occasions, receiving a discovery burst before the one or more wake-up occasions, receiving one or more on-demand RS before the one or more wake-up occasions, or receiving a light SSB before the one or more wake-up occasions.

Preferably or in some embodiments, the wake-up request is carried by a sequence-based signal, wherein a generation of the wake-up request is related to at least one of: a state identification, a common signal transmission period index, a root sequence index, or an initialization seed.

Preferably or in some embodiments, one or more transmission occasions of the wake-up request is associated with a number of SSB indexes or is a certain number of consecutive occasions, and the certain number is equal to a number of actual transmitted SSBs.

Preferably or in some embodiments, the SSB indexes and the one or more transmission occasions of the wake-up request are mapped in an association period, and a length of the association period is a number of times of a period of one of the wake-up request transmission occasions or a number of times of an SSB period.

Preferably or in some embodiments, in response to a pre-configured wake-up occasion being not associated with an SSB index or an SSB corresponding to the pre-configured wake-up occasion not existing, the pre-configured wake-up occasion is not used for transmitting the wake-up request, or
the wake-up request is transmitted with a reference of at least one of: a nearest PRACH occasion, a history transmission information, or a default configuration.

Preferably or in some embodiments, in response to transmissions of the wake-up request and another uplink signal being overlapped in a same slot on a serving cell, one of the wake-up request or the another uplink signal is transmitted according to a priority index or a default configuration.

Preferably or in some embodiments, the wake-up information is carried by one or more random-access preambles with at least one of: a specific PRACH preamble format, a specific Radio Network Temporary Identifier, RNTI, or a PRACH resource.

Preferably or in some embodiments, the wireless communication node receives the wake-up request in an energy saving state, wherein the energy saving state indicates at least one of: no downlink common signal being transmitted, a common signal or channel being transmitted with a large cycle, or only an on-demand signal being transmitted.

Preferably or in some embodiments, the wireless communication node performs at least one of the following operations before receiving the wake-up request: transmitting SSBs with a pre-defined cycle, transmitting SSBs N times before the one or more wake-up occasions, transmitting a Tracking Reference Signal, TRS, before the one or more wake-up occasions, transmitting a discovery burst before the one or more wake-up occasions, transmitting one or more on-demand RS before the one or more wake-up occasions, or transmitting a light SSB before the one or more wake-up occasions.

The present disclosure also relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 shows a schematic diagram of a wireless terminal according to an embodiment of the present disclosure.

FIG. 2 shows a schematic diagram of a wireless network node according to an embodiment of the present disclosure.

FIGS. 3 and 4 shows flowcharts for wireless communication methods according to an embodiment of the present disclosure.

### DETAILED DESCRIPTION

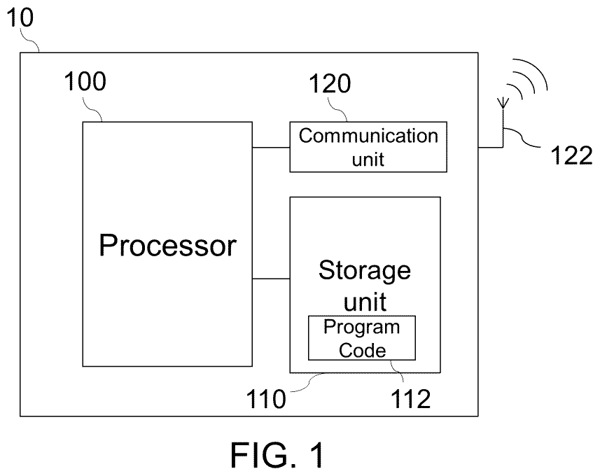

FIG. 1 relates to a schematic diagram of a wireless terminal (e.g., wireless communication terminal) 10 according to an embodiment of the present disclosure. The wireless terminal 10 may be a user equipment (UE), a mobile phone, a laptop, a tablet computer, an electronic book or a portable computer system and is not limited herein. The wireless terminal 10 may include a processor 100 such as a microprocessor or Application Specific Integrated Circuit (ASIC), a storage unit 110 and a communication unit 120. The storage unit 110 may be any data storage device that stores a program code 112, which is accessed and executed by the processor 100. Embodiments of the storage unit 112 include but are not limited to a subscriber identity module (SIM), read-only memory (ROM), flash memory, random-access memory (RAM), hard-disk, and optical data storage device. The communication unit 120 may a transceiver and is used to transmit and receive signals (e.g., messages or packets) according to processing results of the processor 100. In an embodiment, the communication unit 120 transmits and receives the signals via at least one antenna 122 shown in FIG. 1.

In an embodiment, the storage unit 110 and the program code 112 may be omitted and the processor 100 may include a storage unit with stored program code.

The processor 100 may implement any one of the steps in exemplified embodiments on the wireless terminal 10, e.g., by executing the program code 112.

The communication unit 120 may be a transceiver. The communication unit 120 may as an alternative or in addition be combining a transmitting unit and a receiving unit configured to transmit and to receive, respectively, signals to and from a wireless network node (e.g., a base station).

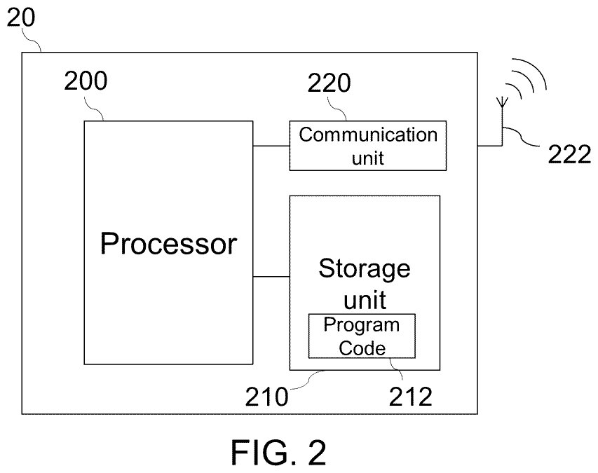

FIG. 2 relates to a schematic diagram of a wireless network node (e.g., wireless communication node) 20 according to an embodiment of the present disclosure. The wireless network node 20 may be a satellite, a base station (BS), a smart node, a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 20 may comprise (perform) at least one network function such as an access and mobility management function (AMF), a session management function (SMF), a user place function (UPF), a policy control function (PCF), an application function (AF), etc. The wireless network node 20 may include a processor 200 such as a microprocessor or ASIC, a storage unit 210 and a communication unit 220. The storage unit 210 may be any data storage device that stores a program code 212, which is accessed and executed by the processor 200. Examples of the storage unit 212 include but are not limited to a SIM, ROM, flash memory, RAM, hard-disk, and optical data storage device. The communication unit 220 may be a transceiver and is used to transmit and receive signals (e.g., messages or packets) according to processing results of the processor 200. In an example, the communication unit 220 transmits and receives the signals via at least one antenna 222 shown in FIG. 2.

In an embodiment, the storage unit 210 and the program code 212 may be omitted. The processor 200 may include a storage unit with stored program code.

The processor 200 may implement any steps described in exemplified embodiments on the wireless network node 20, e.g., via executing the program code 212.

The communication unit 220 may be a transceiver. The communication unit 220 may as an alternative or in addition be combining a transmitting unit and a receiving unit configured to transmit and to receive, respectively, signals to and from a wireless terminal (e.g., a user equipment or another wireless network node).

In an embodiment, a network device detects a wake-up request (e.g., a wake-up signal or channel (referred to WUS hereinafter)) only when the network device is in the energy saving state. The energy saving state refers to one or more of no DL common signal or channel transmitted, the common signal or channel transmitted with a large cycle, only on-demand signal transmitted. The common signal or channel comprises at least one of SSBs, SIBs, a paging, a SRS or a PRACH.

The wake-up information comprises at least one of: an indication indicating one or more of the common signal or channel transmissions (e.g., the transmissions of the common signals or channels), an indication indicating one or more of the common signal or channel receptions (e.g., the receptions of the common signals or channels), or a feedback transmitted to the wireless communication node.

In the embodiment, the operations of the network device correspond to the wake-up request comprising at least one of transmitting SSBs, transmitting SIBs, receiving PRACHs, receiving SRSs, transmitting paging, transmitting one or more on-demand reference signal or transmitting a feedback to the wireless communication node. Details will be described below.

### 1—Transmits SSBs

In some embodiments, when the network device detects the wake-up signal or channel, the network device transmits SSBs from the next SSB burst.

In some embodiments, the network device transmits SSBs N times periodically from the next SSB burst occasion, wherein N is determined by at least one of a fixed value (e.g., N=1 or N=2), or configured by one or more high layer parameters.

In some embodiments, the network device transmits SSBs N times repeatedly within one or more SSB cycle from the next SSB burst, wherein N is determined by at least one of a fixed value (e.g., N=1 or N=2), configured by one or more high layer parameters, or the SSB cycle or the duration between two SSB occasions.

In some embodiments, the network device transmits SSBs within a duration periodically.

In some embodiments, the duration may be associated with (or determined by) at least one of a fixed value (e.g., 40 ms), configured by one or more high layer parameters, X times of the SSB cycle, X≥1, or the RACH procedure. For example, the network device transmits the SSBs during the PRACH procedure, when the RACH procedure is ended, the network device stops to transmit the SSB.

In some embodiments, the duration may take effect immediately after the signal/channel is detected. Alternatively, the duration may take effect after an offset. In another alternative, the duration may take effect from next SSB burst occasion.

In some embodiments, the network device transmits SSBs with a new period from the next SSB burst. The new SSB period is determined by at least one of: a pre-defined value, configured by one or more high layer parameters, and indicated by the wake-up signal/channel.

In some embodiments, the network device transmits SSBs with a new period M times, wherein M≥1.

In some embodiments, the network device transmits SSBs with a new period within a duration.

In some embodiments, the network device transmits SSBs with a new period until a transmission timer expired.

In some embodiments, the network device transmits SSBs with a new period until the network device receives a new indication.

In some embodiments, the new SSB period is broadcast by the SIB.

In some embodiments, the new SSB period is indicated to the UE by a feedback.

### 2—Transmits SIB

In some embodiments, the network device transmits SIBs N times periodically from the next SIB occasion, wherein N is determined by at least one of a fixed value (e.g., N=1 or N=2), or configured by one or more high layer parameters.

In some embodiments, the network device transmits SIBs within a duration periodically. The duration is determined by at least one of a fixed value (e.g., 40 ms), configured by one or more high layer parameters, or the M times of SIB cycle. In some embodiments, the duration may take effect: immediately after the signal/channel is detected, after an offset, or from the next SIB occasion.

In some embodiments, the network device transmits SIBs with a new period from the next SIB occasion. The new SIB period is determined by at least one of a pre-defined value, configured by one or more high layer parameters, indicated by the signal/channel.

In some embodiments, the network device transmits SIBs with a new period: M times, where M≥1; or within a duration; or until a transmission timer expired, or until the network device receives a new indication.

In some embodiments, the SIB comprises at least one of the following: the state of the network device (e.g., whether the network device is in energy saving state or not), the configuration about the common signal transmission (e.g., the adopted period of the common signal), the configuration about the WUS (e.g., the WUS occasion related configuration), whether the WUS transmission is enabled or not.

### 3—Receives PRACH

In some embodiments, the network device may not detect the RACH until it receives the wake-up signal/channel.

In some embodiments, the network device may detect the RACH from the RACH occasion after it receives the wake-up signal/channel. In some other embodiments, the network device may detect the RACH from the RACH occasion after N SSB burst occasion after the network device receives the wake-up signal/channel.

### 4—Receives SRS

In some embodiments, the network device detects the SRS after receiving the WUS.

### 5—Transmits Paging

In some embodiments, the network device transmits the paging after receiving the WUS.

### 6—Transmits a Feedback to UE

In some embodiments, the network device transmits a feedback to the UE after receiving the WUS. The feedback comprises at least one of an ACK/NACK (e.g., whether a WUS is detected successfully), an index of the common signal transmission period, or the common signal transmission period change information (e.g., the feedback includes the information of whether the common signal transmission period is changed or not).

### 7—Transmits One or More On-Demand Reference Signal (RS)

In some embodiments, the network device transmits one or more on-demand RS after receiving the WUS. The on-demand RS can be TRS, CSI-RS or other reference signals.

In an embodiment, the network device may not detect the WUS on the WUS occasions within the validation time of the WUS.

In some other embodiments, the network device detects the WUS on the WUS occasions. When a new WUS within the validation time of the WUS with the same information is detected, the operation of the network device is restarted.

In an embodiment, when a new WUS within the validation time of the WUS with the same information is detected, the network device may ignore the new received wake-up information.

### WUS Occasion

In an embodiment, WUS occasion is associated with at least one of: a WUS occasion cycle; an indication information; a RACH occasion; a paging occasion; a paging frame, PF; or a PEI occasion.

In some embodiments, when the WUS occasion is associated with a WUS occasion cycle, the cycle of the WUS occasion is associated with at least one of: one or more high layer parameters. (e.g., the cycle of the WUS occasion is a pre-defined value configured by one or more high layer parameters. In an embodiment, there are a list of WUS occasion cycle candidate, and one of them can be chosen), a paging cycle (e.g., the transmission occasion period of the signal equals to the paging cycle or equals to the multiple of the paging cycle), a SSB transmission period, a discovery burst duty cycle or a pre-determined value (e.g., the transmission occasion only exists on the specified SFN, therefore, the number of transmission occasions allowed on 1024 radio frames determines the transmission occasion period).

In some embodiments, the WUS occasion is on the specific SFN. For example, the specific SFN is equal to N times of a fixed value. In another example, the specific SFN is equal to 0, that is the transmission occasion only exists on the frame 0.

In some embodiments, the transmission occasion is associated with a duty cycle and an SSB.

In some embodiments, when the WUS occasion is associated with an indication information, the transmission occasion is determined by at least one of the following: a gNB state transition, an indication information (e.g., an indication information carried by SIB).

In some embodiments, when the WUS occasion is associated with a RACH occasion, the WUS occasion is associated with a RACH occasion. The association relationship between the WUS occasion and the RACH occasion includes at least one of: the location of the of the WUS occasion is the same as the RACH occasion, the WUS occasion is a sub-set of the RACH occasion, or the WUS occasion is close to the RACH occasion

In some embodiments, when the WUS occasion is associated with a paging occasion, the WUS occasion corresponds to a paging occasion. For example, there is an offset between the WUS occasion and the paging occasion. The UE can transmit the WUS on the WUS occasion corresponding to the UE's paging occasion.

In some embodiments, when the WUS occasion is associated with a Paging Frame (PF), there is an offset between the WUS occasion and the start of the PF. In some embodiments, each PF corresponds to a WUS occasion. In some embodiments, only some of the PF corresponds to a WUS occasion. In some embodiments, the UE can transmit the WUS on the WUS occasion corresponding to the related PF.

In some embodiments, when the WUS occasion is associated with a Paging Early Indication (PEI) occasion, there is an offset between the WUS occasion and the PEI occasion. In some embodiments, the UE can transmit the WUS on the WUS occasion corresponding to the PEI occasion of the UE.

### WUS Transmission

In an embodiment, whether the UE transmits the wake-up signal or channel is associated with at least one of the following: the measurement results (e.g., the UE transmits the WUS when the RSRP (reference signal received power) is lower than a threshold, or the UE does not detect any of the SSB, CSI-RS within a duration), the random access requirement, the data transmission requirement, the state of the network device (e.g., the UE transmits the WUS when the network device is on the energy saving state, wherein the energy saving state refers to one or more of no DL common signal transmitted, the common signal transmitted with a large cycle, only on-demand signal transmitted), the WUS occasion is enabled, UE fails to detect common signal within a duration.

In some embodiments, the state of the network device, that is whether the network is in energy saving state or not, is broadcast by the SIB.

In some embodiments, whether the WUS occasion is enabled or not is broadcast by the SIB. When the WUS occasion is enabled, the UE transmits the WUS when the RSRP is lower than a threshold.

In some embodiments, the UE detects the common signal with a default or configured period. When there is no common signal detected within a duration, and the UE has a data transmission requirement, the UE transmits the WUS.

In some embodiments, the operations of the UE before transmitting the wake-up signal/channel comprises at least one of the following: receiving the SSBs with a pre-defined cycle, receiving SSBs N times before the WUS occasion, receiving the TRS before the WUS occasion, receiving the discovery burst before the WUS occasion, receiving on-demand RS or receiving the light SSB (e.g., including PSS and SSS) before the WUS occasion.

In some embodiments, the operations of network device before detecting the wake-up signal/channel comprises at least one of the following: transmitting the SSB with a pre-defined cycle, transmitting SSBs N times before the WUS occasion, transmitting the TRS before the WUS occasion, transmitting the discovery burst before the WUS occasion, transmitting on-demand RS or transmitting the light SSB (e.g., including PSS and SSS) before the WUS occasion.

### WUS (Wake-Up Signal/Channel)

In an embodiment, the wake-up indication information is carried by a sequence-based signal or a RA-based channel.

### 1) Sequence-Based Signal

In some embodiments, the wake-up signal where the wake-up indication information carried is a sequence-based signal.

### 1.1) The Generation of the Wake-Up Signal

In some embodiments, the format of the wake-up signal is based on ZC (Zadoff Chu) sequence, or PN (Pseudo-Noise) sequence.

In some embodiments, the generation of the of the wake-up signal is related to at least one of the following: a state identification (e.g., a state index), a common signal transmission period index, a root sequence index, or a initialization seed. For example, the sequence-based signal is related to a common signal transmission period index, different common signal transmission period index corresponds to different wake-up indication sequence, when the sequence is detected, the indication information is transmitted. In another example, the different wake-up indication information corresponds to different root sequence index, the wake-up indication information can be detected according to different root sequence index.

In some embodiments, the WUS is a sequence. In some embodiments, the WUS is a set of sequences. For example, each WUS sequence corresponds to one index of the common signal transmission period or one network device state.

1.2) Mapping with SSB

In some embodiments, the transmission occasion of the wake-up signal is associated with a number N of SS/PBCH block indexes. When N is larger than 1, the wake-up signal transmitted on the transmission resource associates with the SS/PBCH block index is in increasing order. For example, N=2, the first half of the wake-up signal resource corresponds to SS/PBCH block index=0, and the second half of the wake-up signal resource corresponds to SS/PBCH block index=1. The wake-up signal resource can be sorted in an increasing order of frequency resource indexes for frequency multiplexed WUS transmission occasions, in an increasing order of time resource indexes for time multiplexed WUS transmission occasions, or in an increasing order of indexes for WUS transmission slots.

In some embodiments, the transmission occasion of the wake-up signal is S consecutive occasions, wherein S is the number of actual transmitted SSBs. Each WUS transmission occasion corresponds to one SS/PBCH block indexes. In some embodiments, only N of S WUS occasions are used for WUS transmission, where, the N occasions correspond to the N SS/PBCH block index with the best measurement result.

In some embodiments, the SS/PBCH block indexes to WUS transmission occasions are mapped in an association period. In some embodiments, the association period is from frame 0. In some embodiments, the association period is certain times the WUS transmission occasion period. In some embodiments, the association period is certain times the SSB period.

In some embodiments, when the WUS occasions not associated with SS/PBCH block indexes or the SSB associated with WUS occasion do not exist, the occasions are not used for WUS transmissions. In some embodiments, when the WUS occasions are not associated with SS/PBCH block indexes or the SSB associated with WUS occasion do not exist, the occasions are, used for WUS transmission with a reference of the nearest PRACH occasion. In some embodiments, when the WUS occasions are not associated with SS/PBCH block indexes or when the SSB associated with WUS occasion do not exist, the occasions are used for WUS transmission with a reference of a history transmission information. In some embodiments, when the WUS occasions are not associated with SS/PBCH block indexes or the SSB associated with WUS occasion do not exist, the occasions are used for WUS transmission with a reference of a default configuration.

### 1.3) Specific Signal/Channel

In some embodiments, the transmission occasion of the wake-up signal is associated with the specific signal/channel. The specific signal/channel comprises at least one of: discovery burst; Tracking Reference Signal; and light SSB.

### 1.4) Resource Conflict

In some embodiments, when the WUS and other UL transmission (e.g., PRACH) overlap in the same slot on a serving cell, UE transmits the signal or channel according to a priority index, wherein the priority index is configured by one or more high layer parameters.

In some embodiments, when the WUS and other UL transmission (e.g., PRACH) are transmitted in the same slot on a serving cell, UE transmits the signal or channel by default. For example, the UE does not transmit the WUS when the WUS occasions are in conflict with a PRACH resource. In another example, the UE does not transmit the PRACH in the case of overlapping symbol(s).

In some other embodiments, when the WUS overlaps in the same slot with the DL signal or channel, such as SSB, SIB, or TRS, the UE does not transmit the WUS.

### 2) RA-Based Channel

In an embodiment, the wake-up indication information is carried by a physical random access channel (PRACH).

In some embodiments, the wake-up indication information is carried by one or more random-access preambles with at least one of the following: a specific PRACH preamble format; a specific RNTI; or a PRACH resource.

In some embodiments, the wake-up indication information is carried by a sequence-based signal transmitted on the PRACH resource.

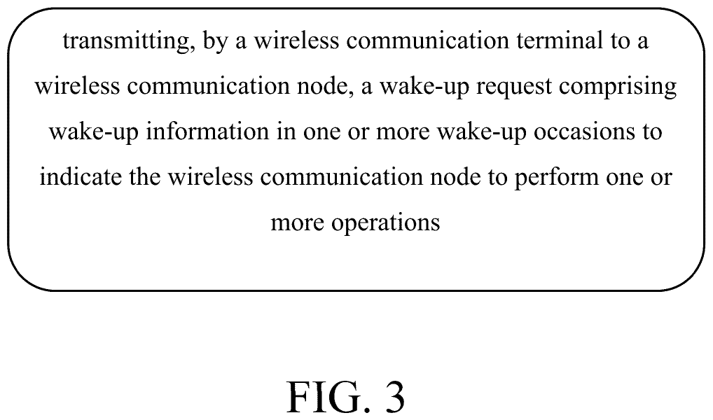

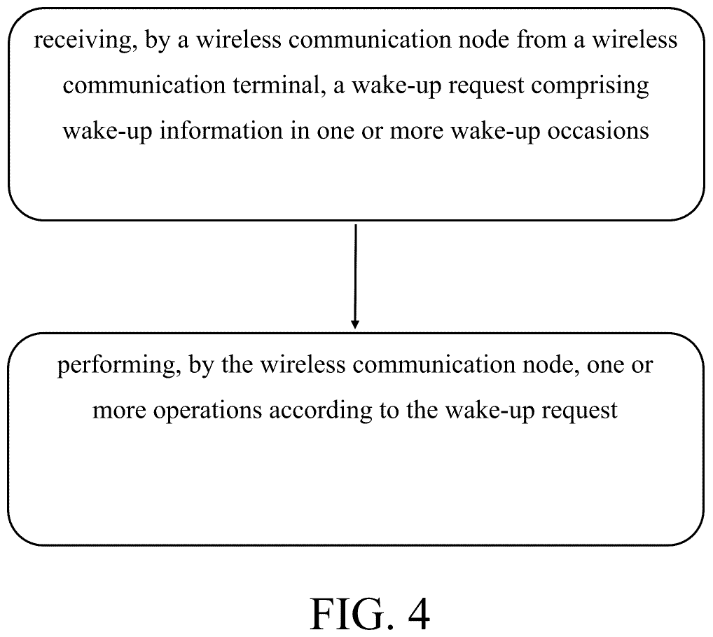

FIGS. 3 and 4 shows flowcharts for wireless communication methods according to an embodiment of the present disclosure.

A wireless communication method is provided according to an embodiment of the present disclosure. In an embodiment, the wireless communication method may be performed by using a wireless communication terminal (e.g., a UE). In an embodiment, the wireless communication terminal may be implemented by using the wireless communication terminal 70 described above, but is not limited thereto.

As illustrated in FIG. 3, in an embodiment, the wireless communication method includes: transmitting, by a wireless communication terminal to a wireless communication node, a wake-up request comprising wake-up information in one or more wake-up occasions to indicate the wireless communication node to perform one or more operations.

Details in this regard can be ascertained with reference to the paragraphs above, and will not be repeated herein.

Another wireless communication method is provided according to an embodiment of the present disclosure. In an embodiment, the wireless communication method may be performed by using a wireless communication node (e.g., a base station or a gNB). In an embodiment, the wireless communication terminal may be implemented by using the wireless communication node 80 described above, but is not limited thereto.

As illustrated in FIG. 4, in an embodiment, the wireless communication method includes: receiving, by a wireless communication node from a wireless communication terminal, a wake-up request comprising wake-up information in one or more wake-up occasions; and performing, by the wireless communication node, one or more operations according to the wake-up request.

Details in this regard can be ascertained with reference to the paragraphs above, and will not be repeated herein.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

We claim:

1. A wireless communication method comprising:
transmitting, by a wireless communication terminal to a wireless communication node, a wake-up request comprising wake-up information in one or more wake-up occasions to indicate the wireless communication node to perform one or more operations.

2. The wireless communication method of claim 1, wherein the wake-up information comprises at least one of: an indication indicating one or more of the common signal or channel transmissions, an indication indicating one or more of the common signal or channel receptions, or a feedback transmitted to the wireless communication node,
wherein, the common signal or channel comprises at least one of a Synchronization Signal/Physical Broadcast Channel Block (SSB), a System Information Block (SIB), a paging, a Sounding Reference Signal (SRS), or a Physical Random Access Channel (PRACH);
wherein the one or more operations comprises at least one of: transmitting SSBs, transmitting SIBs, receiving a PRACH, receiving SRS, transmitting paging, transmitting on-demand reference signal, RS, or transmitting a feedback to the wireless communication node;
wherein transmitting the SSBs comprises at least one of: transmitting SSBs a predetermined number of times periodically from a next SSB burst occasion, transmitting SSBs a predetermined number of times repeatedly within one or more SSB cycles, transmitting SSBs within a duration periodically, or transmitting SSBs with a new SSB period from a next SSB burst occasion;
wherein transmitting the SIBs comprises at least one of: transmitting SIBs a predetermined number of times periodically from a next SIB occasion, transmitting SIBs within a duration periodically, or transmitting SIBs with a new SIB period from a next SIB burst occasion;
wherein at least one of the predetermined number, the duration, the new SSB period, or the new SIB period is associated with at least one of a fixed value, configured by high layer parameter, times of SSB cycle, or times of SIB cycle.

3. The wireless communication method of claim 1, wherein the wake-up request is not detected by the wireless communication node within a validation time of the wake-up request, or
the one or more operations are restarted when a new wake-up request is detected within a validation time of the wake-up request, or
the wake-up information in the new wake-up request is ignored when the new wake-up request is detected within a validation time of the wake-up request.

4. The wireless communication method of claim 1, wherein the wake-up occasions are associated with at least one of: a cycle of the one of the wake-up occasions, indication information transmitted from the wireless communication node to the wireless communication terminal, a random access channel (RACH) occasion, a paging occasion, a paging frame (PF), or a paging early indication (PEI), wherein the cycle of the wake-up occasions is associated with at least one of: a high layer parameter, a paging cycle, an SSB transmission period, a discovery burst duty cycle, or a predetermined value.

5. The wireless communication method of claim 1, wherein the wake-up request is transmitted according to at least one of: a measurement result, a random access requirement, a data transmission requirement, a state of the wireless communication node, the one or more wake-up occasions are enabled, or an event that the wireless communication terminal fails to detect a common signal within a duration.

6. The wireless communication method of claim 1, wherein the wireless communication terminal performs at least one of the following operations before transmitting the wake-up request: receiving SSBs with a pre-defined cycle, receiving SSBs N times before the one or more wake-up occasions, receiving a Tracking Reference Signal (TRS), before the one or more wake-up occasions, receiving a discovery burst before the one or more wake-up occasions, receiving one or more on-demand RS before the one or more wake-up occasions, or receiving a light SSB before the one or more wake-up occasions.

7. The wireless communication method of claim 1, wherein the wake-up request is carried by a sequence-based signal, wherein a generation of the wake-up request is related to at least one of: a state identification, a common signal transmission period index, a root sequence index, or an initialization seed;
wherein one or more transmission occasions of the wake-up request is associated with a number of SSB indexes or is a certain number of consecutive occasions, and the certain number is equal to a number of actual transmitted SSBs;
wherein the SSB indexes and the one or more transmission occasions of the wake-up request are mapped in an association period, and a length of the association period is a number of times of a period of one of the wake-up request transmission occasions or a number of times of an SSB period;
wherein in response to transmissions of the wake-up request and another uplink signal being overlapped in a same slot on a serving cell, one of the wake-up request or the another uplink signal is transmitted according to a priority index or a default configuration.

8. The wireless communication method of claim 1, wherein in response to a pre-configured wake-up occasion being not associated with an SSB index or an SSB corresponding to the pre-configured wake-up occasion not existing, the pre-configured wake-up occasion is not used for transmitting the wake-up request, or the wake-up request is transmitted with a reference of at least one of: a nearest PRACH occasion, a history transmission information, or a default configuration.

9. The wireless communication method of claim 1, wherein the wake-up information is carried by one or more random-access preambles with at least one of: a specific PRACH preamble format, a specific Radio Network Temporary Identifier, (RNTI), or a PRACH resource.

10. A wireless communication method comprising:
receiving, by a wireless communication node from a wireless communication terminal, a wake-up request comprising wake-up information in one or more wake-up occasions; and
performing, by the wireless communication node, one or more operations according to the wake-up request.

11. The wireless communication method of claim 10, wherein the wireless communication node receives the wake-up request in an energy saving state, wherein the energy saving state indicates at least one of: no downlink common signal being transmitted, a common signal or channel being transmitted with a large cycle, or only an on-demand signal being transmitted;
wherein the wake-up information comprises at least one of: an indication indicating one or more of the common signal or channel transmissions, an indication indicating one or more of the common signal or channel receptions, or a feedback transmitted to the wireless communication node, wherein, the common signal or channel comprises at least one of a Synchronization Signal/Physical Broadcast Channel Block (SSB), a System Information Block, SIB, a paging, a Sounding Reference Signal (SRS), or a Physical Random Access Channel (PRACH);
wherein the one or more operations comprises at least one of: transmitting SSBs, transmitting SIBs, receiving a PRACH, receiving SRS, transmitting paging, transmitting on-demand reference signal (RS), or transmitting a feedback to the wireless communication node; wherein transmitting the SSBs comprises at least one of: transmitting SSBs a predetermined number of times periodically from a next SSB burst occasion, transmitting SSBs a predetermined number of times repeatedly within one or more SSB cycles, transmitting SSBs within a duration periodically, or transmitting SSBs with a new SSB period from a next SSB burst occasion;
wherein transmitting the SIBs comprises at least one of: transmitting SIBs a predetermined number of times periodically from a next SIB occasion, transmitting SIBs within a duration periodically, or transmitting SIBs with a new SIB period from a next SIB burst occasion;
wherein at least one of the predetermined number, the duration, the new SSB period, or the new SIB period is associated with at least one of a fixed value, configured by high layer parameter, times of SSB cycle, or times of SIB cycle.

12. The wireless communication method of claim 10, wherein the wake-up request is not detected by the wireless communication node within a validation time of the wake-up request, or
the one or more operations are restarted when a new wake-up request is detected within a validation time of the wake-up request, or
the wake-up information in the new wake-up request is ignored when the new wake-up request is detected within a validation time of the wake-up request.

13. The wireless communication method of claim 10, wherein the wake-up occasions are associated with at least one of: a cycle of the one of the wake-up occasions, indication information transmitted from the wireless communication node to the wireless communication terminal, a random access channel (RACH) occasion, a paging occasion, a paging frame (PF), or a paging early indication (PEI), wherein the cycle of the wake-up occasions is associated with at least one of: a high layer parameter, a paging cycle, an SSB transmission period, a discovery burst duty cycle, or a predetermined value.

14. The wireless communication method of claim 10, wherein the wake-up request is transmitted according to at least one of: a measurement result, a random access requirement, a data transmission requirement, a state of the wireless communication node, the one or more wake-up occasions are enabled, or an event that the wireless communication terminal fails to detect a common signal within a duration; or
wherein the wake-up request is carried by a sequence-based signal, wherein a generation of the wake-up request is related to at least one of: a state identification, a common signal transmission period index, a root sequence index, or an initialization seed.

15. The wireless communication method of claim 10, wherein the wireless communication node performs at least one of the following operations before the wake-up occasions: transmitting SSBs with a pre-defined cycle, transmitting SSBs N times before the one or more wake-up occasions, transmitting a Tracking Reference Signal (TRS) before the one or more wake-up occasions, transmitting a discovery burst before the one or more wake-up occasions, transmitting one or more on-demand RS before the one or more wake-up occasions, or transmitting a light SSB before the one or more wake-up occasions.

16. The wireless communication method of claim 10, wherein one or more transmission occasions of the wake-up request is associated with a number of SSB indexes or is a certain number of consecutive occasions, and the certain number is equal to a number of actual transmitted SSBs;
wherein the SSB indexes and the one or more transmission occasions of the wake-up request are mapped in an association period, and a length of the association period is a number of times of a period of one of the wake-up request transmission occasions or a number of times of an SSB period;
wherein in response to transmissions of the wake-up request and another uplink signal being overlapped in a same slot on a serving cell, one of the wake-up request or the another uplink signal is transmitted according to a priority index or a default configuration.

17. The wireless communication method of claim 10, wherein in response to a pre-configured wake-up occasion being not associated with an SSB index or an SSB corresponding to the pre-configured wake-up occasion not existing, the pre-configured wake-up occasion is not used for transmitting the wake-up request, or
the wake-up request is transmitted with a reference of at least one of: a nearest PRACH occasion, a history transmission information, or a default configuration.

18. The wireless communication method of claim 10, wherein the wake-up information is carried by one or more random-access preambles with at least one of: a specific PRACH preamble format, a specific Radio Network Temporary Identifier (RNTI), or a PRACH resource.

19. A wireless communication terminal, comprising:
a transceiver; and
a processor configured to: transmit, via the transceiver to a wireless communication node, a wake-up request comprising wake-up information in one or more wake-up occasions to indicate the wireless communication node to perform one or more operations.

20. A wireless communication node, comprising:
a transceiver; and
a processor configured to perform the wireless communication method of claim 10.
